(19) United States
(12) Patent Application Publication
(10) Pub. No.: US 2011/0196739 A1
(43) Pub. Date: Aug. 11, 2011

(54) SYSTEMS AND METHODS FOR EFFICIENTLY RANKING ADVERTISEMENTS BASED ON RELEVANCY AND CLICK FEEDBACK

(76) Inventors: Ruofei Zhang, San Jose, CA (US); Wei Li, Sunnyvale, CA (US); Jianchang Mao, San Jose, CA (US)

(21) Appl. No.: 12/701,237

(22) Filed: Feb. 5, 2010

(51) Int. Cl. G06Q 30/00; G06F 15/18

(52) U.S. Cl. 705/14.52; 706/12

(57) ABSTRACT

The present invention provides a method and system for ranking and selecting advertisements based on relevancy, click feedback and click over expected click (COEC) data. Advertisements may be described as contextual, page-embedded advertisements appearing on publisher websites. The method and system includes storing page-advertisement relevancy features in a vector space model and historical impression and click features in a click feedback model and analyzing data in the vector space model and click feedback model. The method and system further includes storing empirical click-through data in a serving log and analyzing data therein. The method and system then generates a regression model based on the analyzed data, which is stored in a regression storage module. The method and system receives requests for advertisement content from client devices, selects a plurality of candidate advertisements based on the generated regression model and provides a plurality of advertisements to a client device.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

Embodiments of the invention described herein generally relate to efficiently ranking advertisements based on relevancy and click feedback. More specifically, embodiments of the present invention are directed towards systems and methods for combining advertisement relevancy data and click through data using a tree-based regression model.

### BACKGROUND OF THE INVENTION

For advertisement ranking in contextual advertising, there are two major approaches based on either relevancy between page-advertisement content or user click feedback. The relevancy-based method generates a ranking function from a data set that consists of page-advertisement pairs with editorial judgments. There are several issues with this approach.

First, the training data includes only page-advertisement features, while some other features like publisher information are missing. Secondly, since manual labeling is very time consuming, the training set is small and can only be expanded slowly. Finally, it is an indirect solution to improve click through rates and their correlation is low. In other words, even if the model predicts relevancy well, it alone may not have much impact on the click through rate.

On the other hand, the click-based method does not consider page ad content. It only uses historical statistics for impressions and clicks to predict future probability of click. This approach is called a click feedback model. The historical statistics are collected at multiple levels of granularity. In order to combine all these numbers together to generate a final click feedback score, a maximum entropy model is trained as a binary classifier, where the positive examples are impressions with clicks and negative examples are the ones without clicks.

There are two issues with this approach. First, training examples are very imbalanced for the two classes because the number of clicks is much less than the number of impressions. The performance of the maximum entropy model drops significantly while facing such data sets. The existing solution to this problem is to keep all impressions with clicks and sample those without clicks at a fixed ratio. By doing so, it is unclear whether the sampled data is a good representation of the whole data set and a large number of infrequent page ad pairs may be missing.

Secondly, the impressions without clicks are not necessarily negative examples. There are many reasons why an impression did not lead to a click. For instance, the user may have no intention to click on any advertisement even if they are relevant. These false negative examples bring noises to the training data and affect the model accuracy.

As such, there exists a need to solve the two major problems in the by combining both relevancy and click feedback in ad ranking through curing the problems of imbalanced and noisy training data in the click feedback model.

### SUMMARY OF THE INVENTION

The present invention is directed towards systems and methods for ranking and selecting advertisements based on relevancy and click feedback. Specifically, the present invention is directed towards analyzing relevancy and click feedback data to select contextual advertisements. In alternative embodiments, the present invention may be utilized to select advertisements for a plurality of scenarios including, but not limited to, search engine advertisements. The present invention stores page-advertisement relevancy features in a vector space model as well as historical impression and click features in a click feedback model.

The present invention then analyzes data in the vector space model and click feedback model. In one embodiment, analyzing data in the vector space model and click feedback model further comprises analyzing the contextual similarity between a page-advertisement pair and historical impression and click statistics at multiple levels of granularity.

The present invention then analyzes data in the serving log to estimate normalized click through rates for page-advertisement pairs. In one embodiment, estimating a normalized click through rate further comprises estimating the average click through rate for a source tag at a given position and calculating a click over expected click (COEC) rate for a given page-advertisement pair. In an alternative embodiment, estimating a normalized click through rate further comprises calculating a COEC rate according to the equation 1 noted in the detail description below.

The present invention then generates a regression model based on the analyzed data. In one embodiment, the present invention generating a regression model based on the analyzed data comprises a gradient descent boosting tree. The present invention then stores the regression model in a regression storage module.

From the client perspective, the present invention receives requests for advertisement content from client devices. Given the web page associated with the request, the present invention identifies a plurality of candidate advertisements. The present invention may further predict a COEC rate for each candidate based on the generated regression model. In one embodiment, predicting a COEC rate for a page-advertisement pair further comprises analyzing data in the vector space model and click feedback model. The present invention then selects a subset of identified advertisements based on ranking the identified advertisements on the COEC rate and provides them to a client device. In one embodiment, providing a subset of identified advertisements to a client device further comprises providing advertisements within a web page.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for ranking advertisements based on relevancy and click feedback according to one embodiment of the present invention;

FIG. 2 presents a flow diagram illustrating a method for estimating reference click through rates and empirical page-advertisement impressions and clicks according to one embodiment of the present invention;

FIG. 3 presents a flow diagram illustrating a method for calculating a click over expected click rate according to one embodiment of the present invention; and

FIG. 4 presents a flow diagram illustrating a method for efficiently selecting advertisements in response to a user request according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

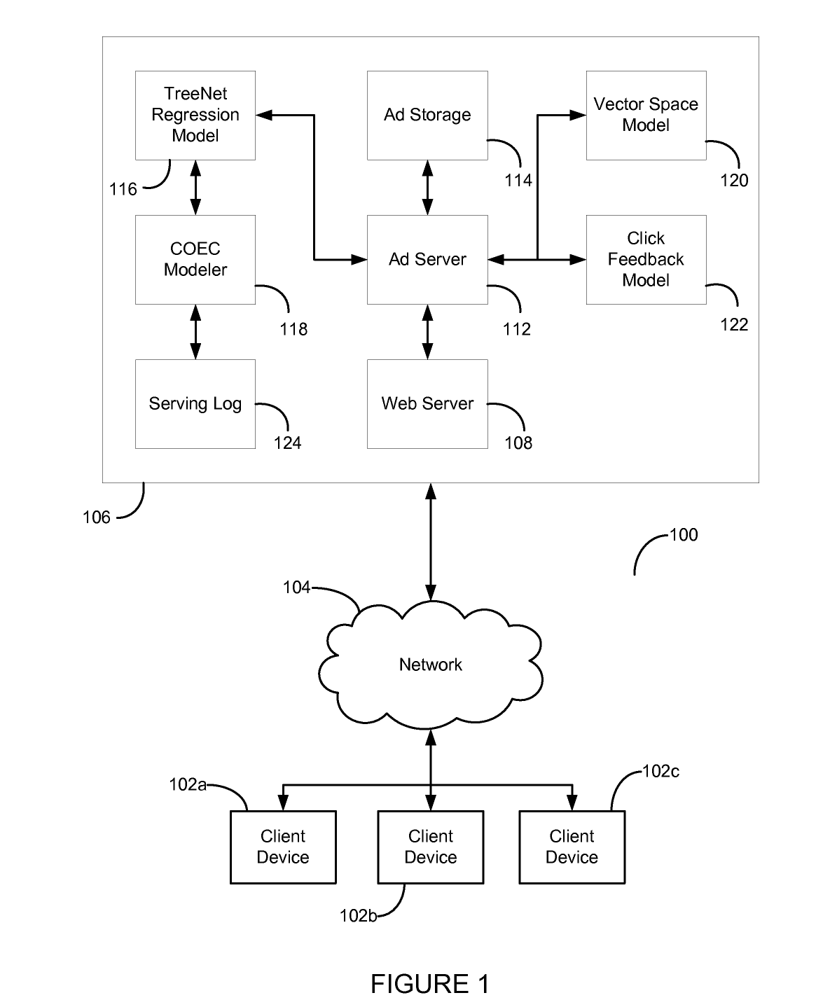

FIG. 1 presents a block diagram depicting a system for ranking advertisements based on relevancy and click feedback according to one embodiment of the present invention. As the embodiment of FIG. 1 illustrates, a plurality of client devices 102a, 102b and 102c are electronically connected to a network 104. Network 104 is further electronically connected to content provider 106. Content provider 106 comprises a plurality of hardware and software components including a web server 108, ad server 112, ad storage 114, TreeNet regression model 116, click over expected click (COEC) modeler 118, vector space model 120, click feedback model 122 and serving log 124.

Client devices 102a, 102b and 102c may be general purpose computing devices (e.g., personal computers, television set top boxes, mobile devices, etc.) having a central processing unit, memory unit, permanent storage, audio/video output devices, network interfaces, etc. Client devices 102a, 102b and 102c are operative to communicate via the network 104, which may be a local or wide area network such as the Internet. In the present embodiment, client devices 102a, 102b and 102c transmit requests to content provider 106 via the HTTP, WAP or similar protocol for the client/server exchange of text, images and other data.

In the illustrated embodiment, the client devices 102a, 102b and 102c may transmit requests for content to web server 108. In one embodiment, requests may comprise requests for search results received through an interface provided by the content provider 106. For example, client devices 102a, 102b, 102c may be operative to retrieve a search interface such as a search portal from content provider 106. The search portal may contain, among other elements, a search form operative to receive text from a user. The search portal may further be operative to send data, including the entered text, to the web server 108.

Web server 108 is coupled to the ad server 112, which may be operative to retrieve ads from ad storage 114 and rank them according to the TreeNet regression model 116, as described herein. In the illustrated embodiment, TreeNet regression model 116 may be populated with data prior to receiving a request. For example, TreeNet regression model 116 may be generated by analyzing advertisement metrics offline to train the model. In the illustrated embodiment, the web server 108 may be operative to receive a user request for a web page. In response, the ad server 112 may calculate page-advertisement relevancy features from the vector space model 120 and page-advertisement historical impression and click features from the click feedback model 122. The ad server 112 may then transmit these features to TreeNet regression model 116 to obtain a predicted COEC rate.

TreeNet regression model 116 may be generated through analysis of page-ad data stored in a vector space model 120, a click feedback model 122 and a serving log 124. In the illustrated embodiment, the TreeNet regression model 116 comprises a non-linear regression model. In one embodiment, vector space model 120 may comprise a plurality of similarity metrics related to pages, advertisements and user data. Click feedback model 122 may store metrics related to historical impression and click statistics at multiple levels of granularity. Serving log 124 may store empirical click-through data of advertisements at given positions.

In the illustrated embodiment, COEC modeler 118 is operative to communicate with the three models 120, 122 and 124 to train a ranking function based on the stored data. The training of the ranking function may be treated as a regression, rather than as a classification problem. Furthermore, the training examples input to the COEC modeler 118 comprise a page-advertisement pair instead of an impression and the target output for the TreeNet regression model 116 is the normalized CTR calculated from empirical click-through data.

COEC modeler 118 is operative to retrieve data from serving log 124. In one embodiment, COEC modeler 118 may be operative to calculate a COEC value for a given page-advertisement pair according the following algorithm:

$$COEC ( page , ad ) = \frac{\sum {click}_{i} ( page , ad )}{\sum {imp}_{i} ( page , ad ) {RCTR}_{i}} \qquad Equation 1$$

Where, impᵢ(page, ad) corresponds to the number of impressions for the page-advertisement pair at position i, RCTRᵢ corresponds to the reference click through rate at position i; and clickᵢ(page, ad) corresponds to the number of clicks for the page-advertisement pair at position i.

The COEC modeler 118 is further operative to transmit COEC values to TreeNet regression model 116. In one embodiment, TreeNet regression model 116 builds a gradient boosting tree comprising a series of decision trees built in a sequential error-correcting process to converge to an accurate regression model. In the illustrated embodiment, TreeNet regression model 116 is operable to directly predict COEC rates for a plurality of selected advertisements and may further be able to rank advertisements based on these rating.

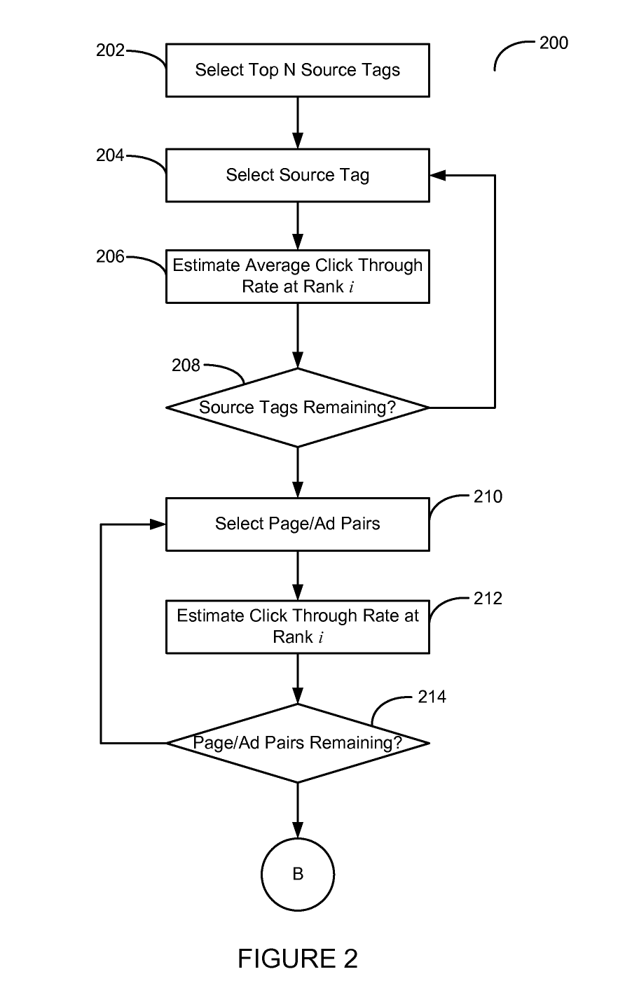

As noted in the flowcharts of FIGS. 2-4 below, the generated COEC values are then usable for placement of advertisements in web content pages. For example, in response to a search engine search request, the selection and placement of ads in a search results page is improved based on the utilization of the COEC data as described herein.

FIG. 2 presents a flow diagram illustrating a method for estimating reference click through rates and empirical page-advertisement impressions and clicks according to one embodiment of the present invention. As the embodiment of FIG. 2 illustrates, the method 200 selects the top N source tags, step 202. In the illustrated embodiment, a source tag may correspond to an identifier identifying a plurality of web pages associated with a given publisher.

The method 200 then selects a given source tag, step 204, and estimates the average click through rate (“reference CTR”) for a given source tag, step 206. In one embodiment, the method 200 estimates a click through rate based on historical data relating to the given source tag. In further embodiments, calculating an average click through rate comprises calculating the average click through rate based on the position of an advertisement on a web page. The method 200 continues estimating the click through rate for the remaining source tags, step 208.

After determining a reference CTR for the plurality of source tags, the method 200 then selects a given page-advertisement pair, step 210, and estimates empirical impressions and clicks of the given page-advertisement pair, step 212. In one embodiment, estimating empirical impressions and clicks may comprise analyzing click-through data at given positions. The method 200 continues to estimate empirical impressions and clicks for a given page-advertisement pair until the list is exhausted, step 214.

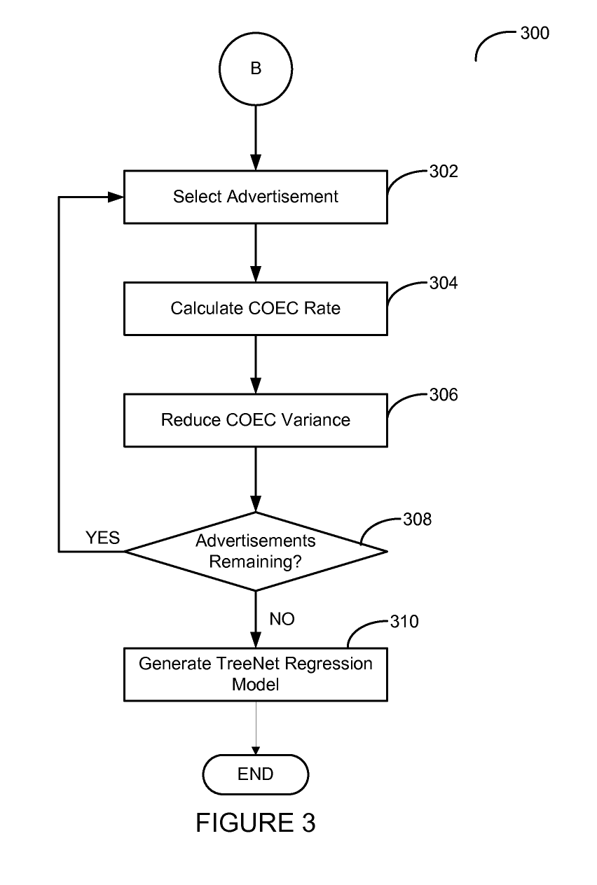

FIG. 3 presents a flow diagram illustrating a method for calculating a click over expected click rate according to one embodiment of the present invention. According to the embodiment that FIG. 3 illustrates, the method 300 selects a page-advertisement pair, step 302. In the illustrated embodiment, selecting a page-advertisement pair may comprise selecting a page-advertisement pair from the list of pairs with estimated impressions and clicks, as discussed with respect to FIG. 2.

The method 300 then calculates a COEC rate for the given page-advertisement pair, step 304. As previously discussed, calculating a COEC rate comprises calculating a value according to the equation illustrated in Equation 1. In the illustrated embodiment, the method 400 may compute the COEC rate according to the algorithm provided previously with respect to Eq. 1.

The method 300 then reduces a COEC variance, step 306, wherein the COEC variance is the noise in the computational system. In one embodiment, reducing the COEC variance may comprise performing log bin on the COEC rate according to the following equation:

Bin=log(COEC*1000) Equation 2:

Equation 2 illustrates an algorithm for calculating the log of 1000 times the COEC rate. This functionality reduces the noise present within the originally calculated COEC and thus reduces the variance for the final model.

After reducing the variance, the method 300 continues to calculate a COEC rate for the remaining page-advertisement pairs and reduces the COEC variance for the remaining page-advertisement pairs, steps 304, 306. After exhausting the list of page-advertisement pairs, the method 300 generates a TreeNet regression model with the COEC values as well as features extracted from the vector space model and the click feedback model, step 310. In one embodiment, generating a TreeNet regression model may comprise generating a non-linear gradient boosting tree model based on the incoming sample set data. That is, the method 300 uses the incoming sample set data to train a ranking function based on the gradient boosting tree model. After training the TreeNet regression model, the method 300 may store the model for subsequent access. Additionally, the method 300 may periodically update the model as deemed fit.

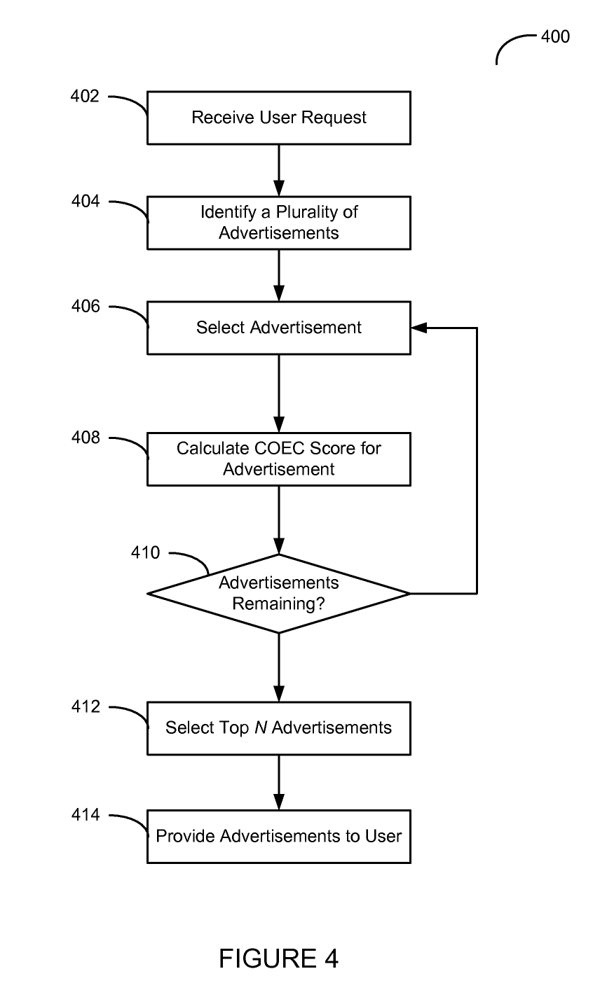

FIG. 4 presents a flow diagram illustrating a method for efficiently selecting advertisements in response to a user request according to one embodiment of the present invention. As the embodiment in FIG. 4 illustrates, a method 400 receives a user request, step 402. In one embodiment, a user request may comprise a request for web content, such as for a search results page in response to user-entered search terms in a search engine interface. In alternative embodiments, the method 400 may receive automated requests, such as requests from remote applications.

The method 400 identifies a plurality of advertisements based on the user request, step 404. In one embodiment, the method 400 may utilize various text processing and historical algorithms in determining the identity of advertisements. For example, the method 400 may analyze the user search terms, advertisement performance, user profile/history, or any other metrics to identify a set of advertisements.

The method 400 selects a given advertisement, step 406, and calculates a COEC score for the advertisement, step 408. In one embodiment, the method 400 may utilize the TreeNet regression model to determine a COEC score. As previously described, the TreeNet regression model may be built based on the metrics analyzed in a page-advertisement vector space model and a click feedback model. The method 400 continues to generate a COEC score for each remaining advertisement, step 410.

The method 400 ranks the advertisements by the COEC score and selects the top N advertisements, step 412. In one embodiment, the method 400 may select the top N advertisements based on a predetermined advertisement maximum. For example, the method 400 may select the number of advertisements based upon the number of available slots on a webpage. Finally, the method 400 then provides the advertisements to the user, step 414. In the illustrated embodiment, the method 400 may include advertisements in a search results page content.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A system for ranking and selecting advertisements based on relevancy and click feedback, the system comprising:
a vector space model operative to store page-advertisement relevancy features;
a click feedback model operative to store historical impression and click features;
a serving log operative to store empirical click-through data;
a click over expected click (COEC) modeler operative to analyze data in the serving log and generate a regression model based on the analyzed data as well as features extracted from the vector space model and click feedback model;
a regression model storage module operative to store the regression model generated by the COEC modeler; and
an advertisement server operative to receive requests for advertisement content from client device, select a plurality of candidate advertisements based on the generated regression model and provide a plurality of advertisements to a client device.

2. The system of claim 1 wherein the COEC modeler is further operative to analyze a page-advertisement pair a given advertisement position.

3. The system of claim 2 wherein the COEC modeler further estimates the average click through rate for a source tag a given position.

4. The system of claim 3 wherein the COEC modeler further estimates the empirical impressions and clicks for a page-advertisement pair at a given position.

5. The system of claim 1 wherein the COEC modeler is further operative to calculate a COEC rate for a given page-advertisement pair.

6. The system of claim 5 wherein the COEC is further operative to calculate a COEC rate according to the following equation:
$$COEC ( page , ad ) = \frac{\sum {click}_{i} ( page , ad )}{\sum {imp}_{i} ( page , ad ) {RCTR}_{i}}$$

7. The system of claim 1 wherein the regression model comprises a gradient descent boosting tree.

8. The system of claim 1 wherein the advertisement server is further operative to predict a COEC rate for a given page-advertisement pair.

9. The system of claim 8 wherein the advertisement server is further operative to select a subset of identified advertisements based on ranking the identified advertisements on the COEC rate.

10. A computerized method for ranking and selecting advertisements based on relevancy and click feedback, the method comprising:
storing page-advertisement relevancy features in a vector space model;
storing historical impression and click features in a click feedback model;
storing empirical click-through data in a serving log;
electronically analyzing data in the vector space model, click feedback model and serving log;
electronically generating a regression model based on the analyzed data;
storing the regression model in a regression storage module;
receiving requests for advertisement content from client devices;
selecting a plurality of candidate advertisements based on the generated regression model; and
providing a plurality of advertisements to a client device.

11. The method of claim 10 wherein analyzing data in the serving log further comprises analyzing a page-advertisement pair a given advertisement position.

12. The method of claim 11, wherein analyzing data in the serving log further comprises estimating the average click through rate for a source tag a given position.

13. The method of claim 12, wherein analyzing data in the serving log further comprises estimating the empirical impressions and clicks for a page-advertisement pair at a given position.

14. The method of claim 10, wherein analyzing data in the serving log further comprises calculating a COEC rate for a given page-advertisement pair.

15. The method of claim 14, wherein analyzing data in the serving log further comprises calculating a COEC rate according to the following equation:
$$COEC ( page , ad ) = \frac{\sum {click}_{i} ( page , ad )}{\sum {imp}_{i} ( page , ad ) {RCTR}_{i}}$$

16. The method of claim 10 wherein generating a regression model based on the analyzed data comprises generating a gradient descent boosting tree.

17. The method of claim 11, further comprising estimating a COEC rate for a given page-advertisement pair.

18. The method of claim 17, further comprising selecting a subset of identified advertisements based on ranking the identified advertisements on the COEC rate.

19. Computer readable media comprising program code that when executed by a programmable processor causes execution of a method for generating search results, the computer readable media including:
program code for storing page-advertisement relevancy features in a vector space model;
program code for storing historical click through data in a click feedback model;
program code for storing empirical click-through data in a serving log;
program code for analyzing data in the vector space model, click feedback model and serving log;
program code for generating a regression model based on the analyzed data;
program code for storing the regression model in a regression storage module;
program code for receiving requests for advertisement content from client devices;
program code for selecting a plurality of candidate advertisements based on the generated regression model; and
program code for providing a plurality of advertisements to a client device.

20. The computer readable media of claim 19, wherein program code for analyzing data in the serving log further comprises program code for calculating a COEC rate for a given page-advertisement pair according to the following equation:
$$COEC ( page , ad ) = \frac{\sum {click}_{i} ( page , ad )}{\sum {imp}_{i} ( page , ad ) {RCTR}_{i}}$$
